(19) United States
(12) Patent Application Publication
(10) Pub. No.: US 2010/0292978 A1
(43) Pub. Date: Nov. 18, 2010

(54) SYSTEM FOR GENERATING COMPUTER PROCESSOR

(75) Inventor: Marc Gandar, Geneva (CH)

Correspondence Address: SEYFARTH SHAW LLP, WORLD TRADE CENTER EAST, TWO SEAPORT LANE, SUITE 300, BOSTON, MA, 02210-2028, US

(73) Assignee: Ecole Polytechnique Federale de Lausanne (EPFL), Lausanne (CH)

(21) Appl. No.: 12/465,879

(22) Filed: May 14, 2009

(51) Int. Cl. G06F 9/455

(52) U.S. Cl. 703/21; 718/1

(57) ABSTRACT

A method and apparatus to produce a net list of gates and Flip-Flops for one algorithm in order to find the best compromise between power consumption, speed and silicon surface by using a two step process. First the algorithm is written for a processor that has no restrictions in terms of number and size of register, core, operations set, memory handler and instructions. The program assembly of this processor fits into a two-dimensional table. To increase speed, the tables are configured to place the program operation in as many columns as possible, and to reduce silicon the tables are configured to place operations in a single column with many rows. The second stage consists of converting this virtual processor with its program tables into an HDL file ready for synthesis.

### FIELD OF THE INVENTION

The present invention relates to computer processors, and more particularly to implementing software instructions in processor hardware.

### BACKGROUND OF THE INVENTION

A typical digital processing system, such as illustrated in FIG. 1, is made to include program memory 10, Input registers 12, Output registers 14 and a processor 16. The processor 16 typically contains a computing core and registers to temporarily store computing results. Processor functionality enables it to read/write to memory and IO registers. Every processor has a dedicated assembly language to enable the operation programming. Assembly operations are basic instructions such as ADD, COMP or MUL to add, compare or multiply information located in memory or inside the processor registers. Some processors compute several operations in one instruction. The program instructions take place, typically, from memory in a linear fashion.

An electronic signal called a Clock enables the processor to read, decode and execute every operation of an instruction. Several clock cycles are usually required to complete an instruction processing. A processor is made of a set of logic gates interconnected by a network. The software sees the processor as an assembly program and the hardware sees the processor as a logic gates net list. This is generally the case in either a FPGA or in an ASIC, as known in the art.

Hardware Description Language (“HDL language”) is used to synthesize a program into a net list provided the program is written according to strict rules. HDLs do not translate a program made of processor assembly instructions into a net list of gates. From a time frame aspect the processor comes before the programs written for the processor. Thus, programs must be adapted to the processor constraints.

### SUMMARY OF THE INVENTION

The present invention provides a mechanism that converts any algorithm, written in a language such as C or assembler, into a net list of logic gates. The net list eventually includes the algorithm program and processor. It is made of registers, computing units (Core), operations set, instructions list, IO channels and an external memory handler. An electronic clock drives the net list to enable the production of the expected algorithm's results after a number of given clock transitions.

The system and method according to the invention aims to produce a net list of gates and flip-flops for one algorithm in order to find the best compromise between power consumption, speed and silicon surface by using a two step process. First the algorithm is written for a processor that has no restrictions in terms of number and size of register, core, operations set, memory handler and instructions. The program assembly of this processor fits into a two-dimensional table. To increase speed, the program operation is placed in as many columns as possible, and to reduce silicon the operation is placed in a single column with many rows. The second stage consists of converting this virtual processor with its program table into an HDL file ready for synthesis.

### BRIEF DESCRIPTION OF THE DRAWINGS

The foregoing and other features and advantages of the present invention will be better understood from the following detailed description of illustrative embodiments, taken in conjunction with the accompanying drawings in which:

FIG. 1 is a standard digital computer architecture, as known in the art

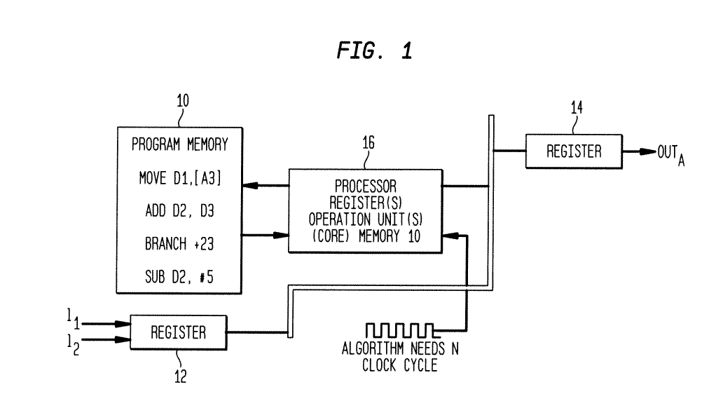

FIG. 2 is an integration of the mechanism according to the invention in a design flow of an ASIC or FPGA;

FIG. 3 is an example of tables of a program according to the invention;

FIG. 4 is a graphic representation of the virtual processor architecture according to the invention; and

FIG. 5 is an external translation example, according to the invention, in HDL language.

### DETAILED DESCRIPTION OF THE INVENTION

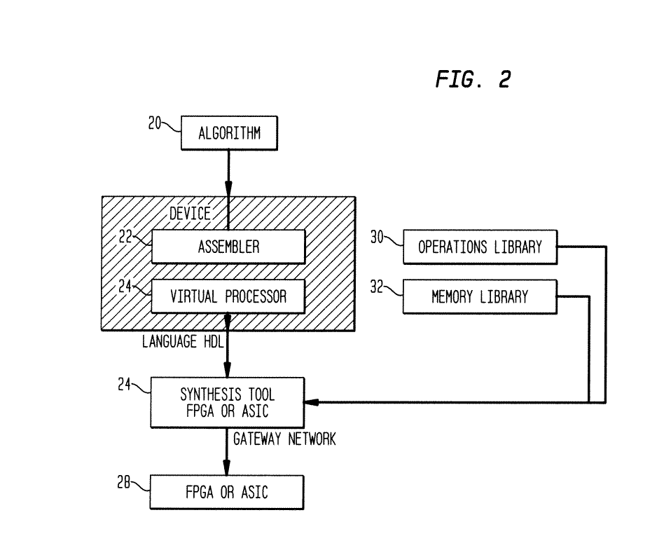

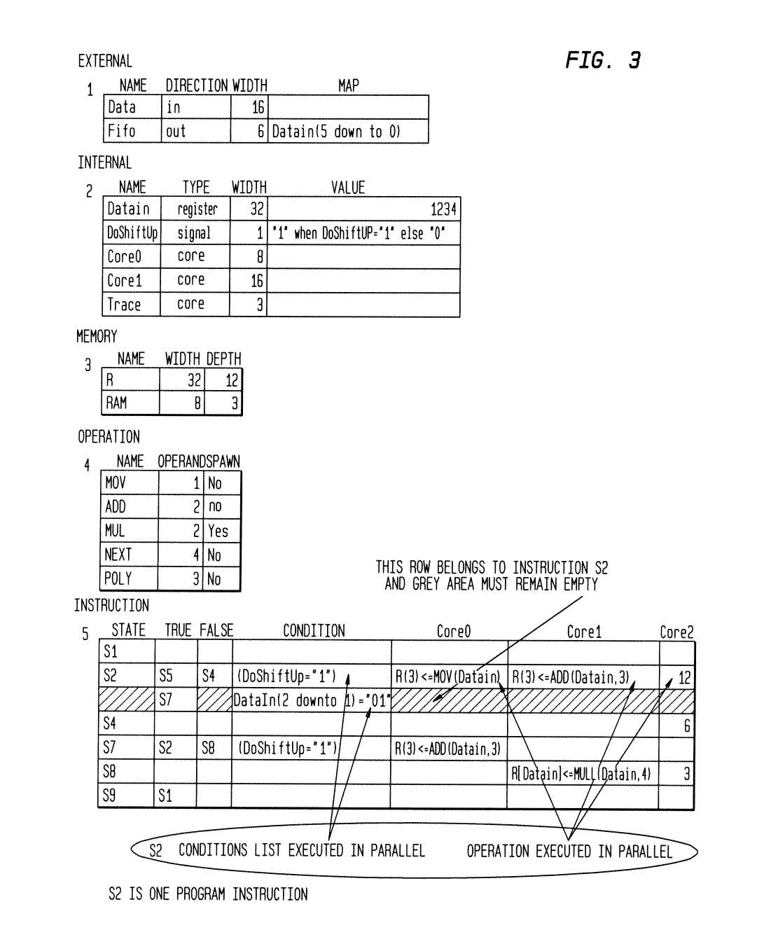

FIG. 2 illustrates the integration of a mechanism according to the invention in the design flow of an Application Specific Integrated Circuit (ASIC) or Field Programmable gate Array (FPGA). The method and apparatus according to the invention may be implemented as a web service in a client—server implementation. According to the invention, the data flow leads from the algorithm down to the logical gates that execute it. The first step consists of translating the algorithm 20 into a programming language such as C/C++ or any other language. The assembler language 22 of the invention is the set of the 5 tables presented further and described hereinafter with respect to FIG. 3. The 5 tables discussed hereinafter can be accessed via a file upload from a server by a programmer at a client system. A programmer populates the tables as described in the illustrative embodiment hereinafter to generate an assembler language version of the program. The assembler language version of the program represented in the 5 tables provides sufficient information to describe a virtual processor. Then, the assembler language 22 gets converted into an HDL text file or virtual state processor 24 returned by the web service ready for synthesis so that the virtual processor as described by the 5 tables of assembler language is converted into an actual, hardware processor such as an ASIC or FPGA, for example.

The silicon design tools, as known in the art, offer the synthesis function 26 that translates the HDL file into a net list of interconnected logical gates. The nest list is then after further automated treatments, as known in the art, converted into an FPGA or an ASIC 28. The algorithm may use arithmetic functions 30 or memory libraries 32 from external libraries. Synthesis tool vendors, as known in the art, provide the memory libraries. The algorithm designer must write the arithmetic operation in a HDL file. These can be the ADD, SUB, COMP instructions present in most processor assembler operations, or custom made algorithms.

The system and method according to illustrative embodiments of the invention implements a mechanism that initially translates an algorithm from program to a virtual processor. The system and method according to the invention delivers a network of gates, or net list, with the characteristic that it includes a program that imposes to a virtual processor the number and the size of registers, memories, operations, instruction and IO lines. In order to produce this network of gates the algorithm is represented in an assembler language having 5 tables illustrated in FIG. 3, and illustratively named External, Internal, Operation, Core, Memory and Instruction. These tables describe the virtual processor architecture and its program. To increase speed, the tables are configured by placing the program operation in as many columns as possible, and to reduce silicon the tables are configured by placing operations in a single column with many rows. The processor is implemented in a second step in the form of an HDL program ready for synthesis.

As illustrated in FIG. 3, external table (1) describes in each row one or a group of electrical wires with a unique name and by specifying the signal outgoing or incoming working direction from the processor stand point.

As illustrated in FIG. 3, internal table (2) describes the set of electrical buses, the computing unit (Core) and the register the processor is made of. One of these components is represented in each row with a unique name and the number of bits it handles (signal), stores (register) or computes (operation unit).

As illustrated in FIG. 3, memory table (3) describes in each row, memory that the virtual processor can access through read/write cycles, the number of bits the memory word is made of and the number words of memory. The assembly enables the programmers to reference a word in a memory by specifying the memory name followed by the address of the word to access specified inside brackets (MemoryName[Address]). The value inside the brackets can be a constant (e.g. 1234), a register (e.g. RegisterName), or an arithmetic operation made of constants and registers. For example, the access in address 3 of memory Mem is written Mem[3] and the access throughout the register Reg will be Mem[reg]. In the form Mem[3+4+(3*5)+(Reg*4)] the memory address corresponds to the result of the expression inside the brackets. At stage 2, the net list generation stage, an additional signal appears to drive the memory such as IO and Address buses or Read/Write/ChipSelect/Wait.

As illustrated in FIG. 3, operation table (4) describes in each row the name of an elementary operation that the operation units may use according to program needs. All operations share the same syntax. One can understand the expression Result<=OperationName(Operand1, . . . , OperandN) as: “puts the results of operation called OperationName into the variable named Result”. Result can be either the name of a register or a memory. Each operation offers several operands. An operand can be a constant (1234), a register (Reg) or a memory (Mem[Reg]). The invention doesn't produce the net list specific to the operation. It does assume that the operation is available in a library with compatible interfaces.

As illustrated in FIG. 3, in instruction table (5) each row contains an instruction of the virtual processor. One part of the instruction gives the row of the next instruction to compute according to an unlimited list of conditions and a destination row. The other part of the instruction contains one operation on every columns cells. The program fixes the number of columns the table has. Execution of conditions and operations in an instruction start at the same clock cycle. The program jumps to the next instruction when all waiting operations are completed. Only one condition of the all conditions list must be true at the instruction execution time to avoid simultaneous instructions execution. After a power reset, the real processor starts executing the first instruction at the top of the table. The table row indirectly represents the timing of execution and the columns represent the ability to execute operations in parallel. A same program can have different amounts of rows and columns but produces the same computing results. Only the execution speed or the silicon surface will change.

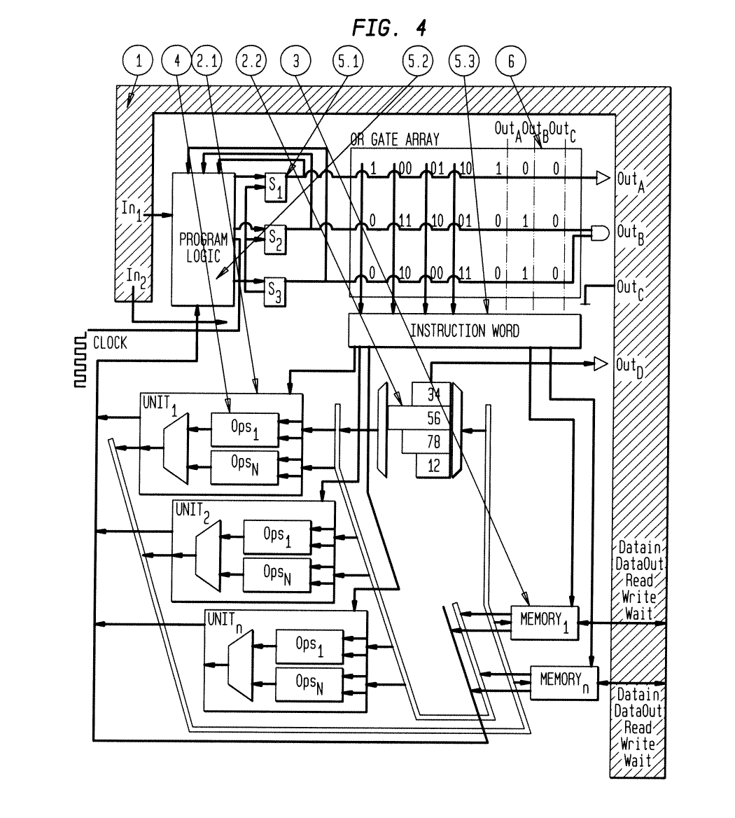

The 5 tables illustrated in FIG. 3 and described above enable the production of an HDL file that contains the program and its virtual processor. In order to convert from the virtual processor as represented by the tables described in relation to FIG. 3, to network of gates, the HDL file is read by a synthesis tool to produce the net list of gates. FIG. 4 is the graphic representation of the virtual processor defined in the HDL file to be read by the synthesis tool.

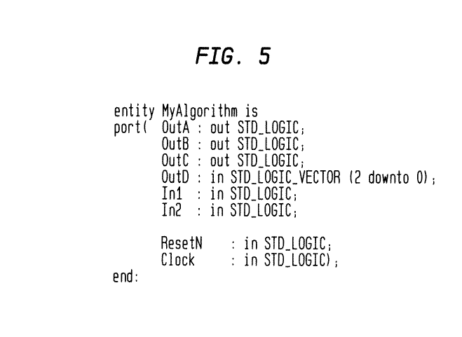

FIG. 5 illustrates corresponding HDL language for the virtual processor illustrated in the graphic representation of FIG. 4.

The External table (1) of FIG. 3 appears in FIG. 4 referenced by the label (1) and in FIG. 5 it appears in corresponding HDL form. Labels (2.1) and (2.2) in FIG. 4 are the Internal table (2) of FIG. 3 where as many (2.1) blocks appear as lines of type (Core) in table (2) of FIG. 3, and where the registers appear pointed by the (2.2) reference. As should be appreciated by those skilled in the art, multiplexers are used to link components of data flow. Table resource (3) of FIG. 3 appears in FIG. 4 pointed to by the label (3). There is the same amount of blocks as the number of lines in the table. Each block has a specific electronic configuration that generates usual signal use to interface a memory such as DataIn, DataOut, Addr, Read, Write, etc, as known to those skilled in the art. Arithmetic operations listed in table (4) of FIG. 3 appear in (2.1) blocks whenever they appear in a column of the table (5) of FIG. 3. The instructions in FIG. 4 referenced by labels (5.1), (5.2) et (5.3) correspond to table (5) of FIG. 3. Label (5.1) associates each line of table (5) of FIG. 3 with Flip-Flops. All of the columns related to logic conditions fit into (5.2) under the format of logic equations and where (5.3) forms the processor instruction word that produces all the signals required to drive the processor components such as multiplexers, cores, memories, registers and IO lines. Each bit of the instruction word corresponds to the output of an OR gate that has a corresponding input to the number of the program line that needs to drive this bit. Actually if no line makes use of a given bit, the bit eventually disappears. One can say that only a logic level “1” leads to the creation of silicon surface but a logic level “0” does not need silicon. Label (6) of FIG. 4 represents the program memory.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A computer implemented system for generating a computer processor, comprising:
an assembler configured to receive a program and translate said program into a plurality of assembler language program instructions representing a virtual processor, said assembler language program instructions including a plurality of 2-dimensional tables; and
means for converting said plurality of program instructions representing a virtual processor into a Hardware Description Language (HDL) textfile representing a said computer processor.

2. The system of claim 1, wherein said tables are configured to increase speed by increasing table columns.

3. The system of claim 1, wherein said tables are configured with a single column to reduce silicon area of said hardware to be generated.

4. The system of claim 1 wherein said system comprises a web service which remotely receives said program via a network and communicates said HDL textfile via said network.

5. The system of claim 1, wherein said tables are selected from the group consisting of external tables, internal tables, memory tables, operation tables and instruction tables.

6. The system of claim 1, wherein said tables include at least one external table having rows which describe a name, signal width and signal direction of external signal paths in said hardware.

7. The system of claim 1, wherein said tables include at least one internal table having rows which describe a name, component type and signal width handled by components of said hardware.

8. The system of claim 1, wherein said tables include at least one memory table having rows which describe memory that said hardware can access through read/write cycles, a number of bits per memory word and a number of words in said memory.

9. The system of claim 1, wherein said tables include at least one operation table having rows which describe operations performed by said hardware.

10. The system of claim 9, wherein each of said operations use a common syntax.

11. The system of claim 1, wherein said tables include at least one instruction table having rows which describe instruction useable by said hardware.

12. The system of claim 11, wherein a part of each instruction as represented in said instruction table provides a row of a next instruction to perform according to conditions in a condition column of said instruction table.

13. A computer implemented method for designing a computer processor, the method comprising:
receiving a program;
translating said program into a plurality of assembler language program instructions representing a virtual processor, said assembler language program instructions including a plurality of 2-dimensional tables; and
converting said plurality of program instructions representing a virtual processor into a Hardware Description Language (HDL) textfile representing a said computer processor.

14. The method of claim 13, further comprising:
configuring said tables to increase speed by increasing table columns.

15. The method of claim 13, further comprising:
configuring said tables with a single column to reduce silicon area of said hardware to be generated.

16. The method of claim 13, wherein said tables are selected from the group consisting of external tables, internal tables, memory tables, operation tables and instruction tables.
